(19) United States
(12) Patent Application Publication
(10) Pub. No.: US 2013/0079925 A1
(43) Pub. Date: Mar. 28, 2013

(54) Medication Management Device

(71) Applicants: Aeed Saad S. Alaklabi, Riyadh (SA); Khalid Mohammed Awad AlGhamdi, Riyadh (SA)

(72) Inventors: Aeed Saad S. Alaklabi, Riyadh (SA); Khalid Mohammed Awad AlGhamdi, Riyadh (SA)

(21) Appl. No.: 13/244,969

(22) Filed: Sep. 26, 2011

(51) Int. Cl. G06F 17/00

(52) U.S. Cl. 700/236

(57) ABSTRACT

A medication management device for assisting a patient with management of health information and medication as well as communicating directly with a health provider regarding compliance. The medication management device generally includes an interior accessible through an access door. The housing will generally include a touch screen display for receiving and displaying data to a patient. The interior will generally include a plurality of medication chambers for storing medications and a plurality of chamber displays for displaying the type of medication stored and various other messages. Data may be entered into the present invention through a data reader, which may be configured to read various types of data such as barcodes. A transceiver is also provided for communicatively interconnecting with mobile devices such as a cell phone or with a doctor's office.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a system for managing medication and more specifically it relates to a medication management device for assisting a patient with management of health information and medication as well as communicating directly with a health provider regarding compliance.

2. Description of the Related Art

Any discussion of the related art throughout the specification should in no way be considered as an admission that such related art is widely known or forms part of common general knowledge in the field.

It is well known that many medications help in alleviating or curing diseases to preserve and elongate human life. However, the ability of medications to provide such benefits are wholly dependent on patient compliance. Patients' failure to comply with medication instructions has been considered a major dilemma in health care. Failure to follow instructions regarding the taking of medications causes an increase in hospital admissions, depletion of beds in hospitals and decreased productivity in a patient's life.

Medical cabinets and other reminder systems have been in use for years; many of which alert patients at the exact time that medication should be taken. While there are many electronic medical reminders currently available, they all lack interactive communication between the patient, physician and pharmacist regarding compliance.

Because of the inherent problems with the related art, there is a need for a new and improved medication management device for assisting a patient with management of health information and medication as well as communicating directly with a health provider regarding compliance.

### BRIEF SUMMARY OF THE INVENTION

The invention generally relates to a medication management device which includes a housing which includes an interior accessible through an access door. The housing will generally include a touch screen display for receiving and displaying data to a patient. The interior will generally include a plurality of medication chambers for storing medications and a plurality of chamber displays for displaying the type of medication stored and various other messages. Data may be entered into the present invention through a data reader, which may be configured to read various types of data such as barcodes. A transceiver is also provided for communicatively interconnecting with mobile devices such as a cell phone or with a doctor's office.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a frontal perspective view of the present invention.

FIG. 2 is a frontal perspective view of the present invention with the access door open.

FIG. 3 is a block diagram illustrating communication between the present invention and mobile devices.

FIG. 4 is an exemplary illustration of screens shown on the display of the present invention.

FIG. 5 is a block diagram illustrating communication between the present invention and a mobile device.

FIG. 6 is an exemplary illustration of screens shown on the display of the present invention.

FIG. 7 is a rear perspective view of the present invention.

### DETAILED DESCRIPTION OF THE INVENTION

### A. Overview.

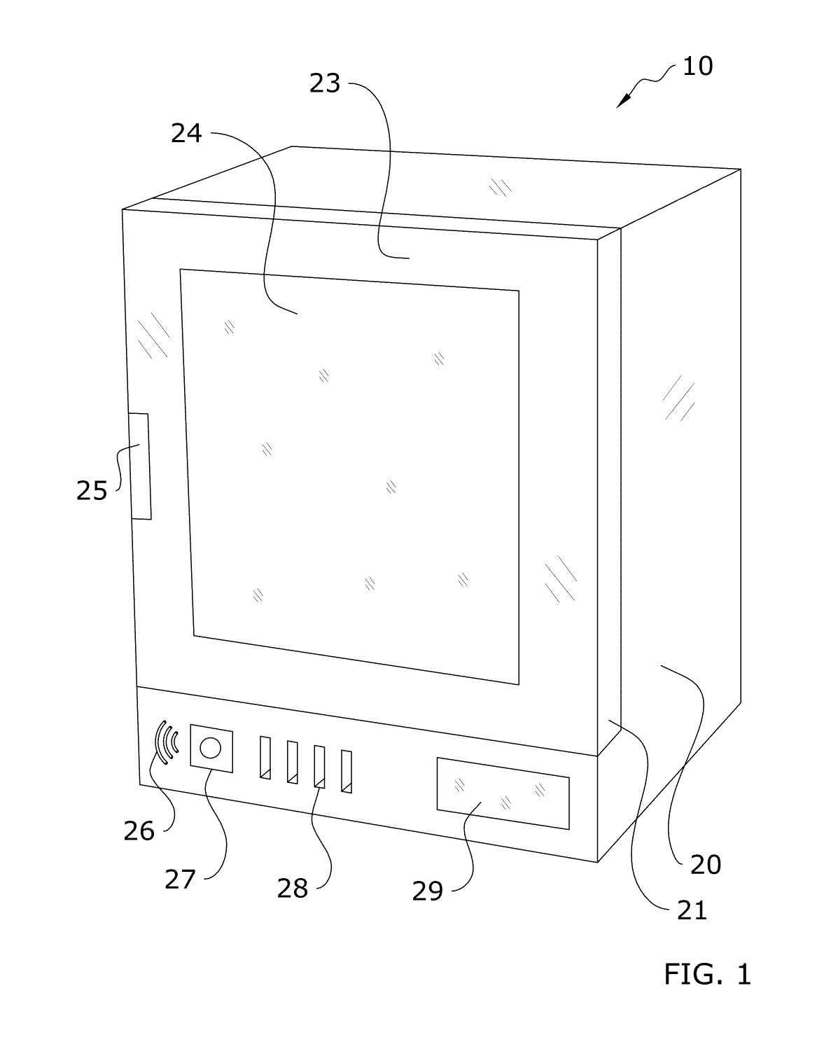

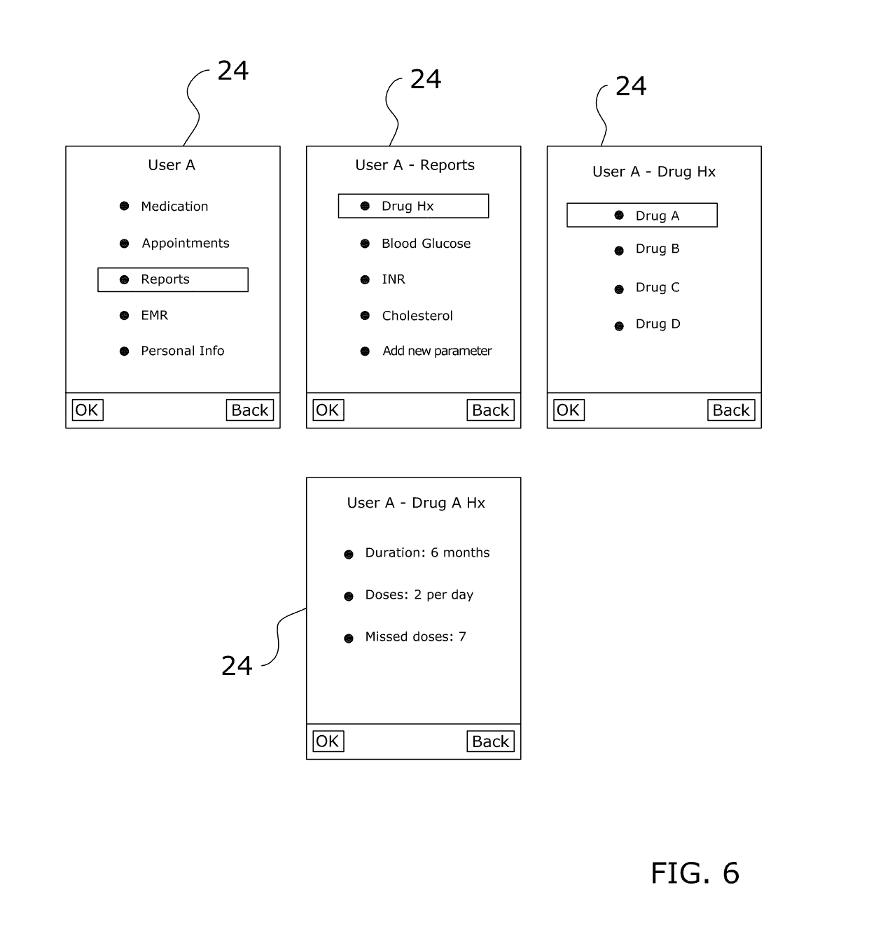

Turning now descriptively to the drawings, in which similar reference characters denote similar elements throughout the several views, FIGS. 1 through 7 illustrate a medication management device 10, which comprises a housing 20 which includes an interior 30 accessible through an access door 23. The housing 20 will generally include a touch screen display 24 for receiving and displaying data to a patient. The interior 30 will generally include a plurality of medication chambers 32 for storing medications and a plurality of chamber displays 33 for displaying the type of medication stored and various other messages. Data may be entered into the present invention through a data reader 27, which may be configured to read various types of data such as barcodes. A transceiver 26 is also provided for communicatively interconnecting with mobile devices 12 such as a cell phone or with a doctor's office 14.

### B. Housing.

The present invention will generally include a housing 20 for storing and dispending medications as well as displaying and communicating health information. As shown in FIG. 1, the housing 20 will preferably be comprised of a substantially rectangular cabinet structure, though it is appreciated that various other configurations may be utilized. Thus, it is appreciated that the shape and design of the housing 20 may vary for different applications and should not be construed as being limited to that which is shown in the figures.

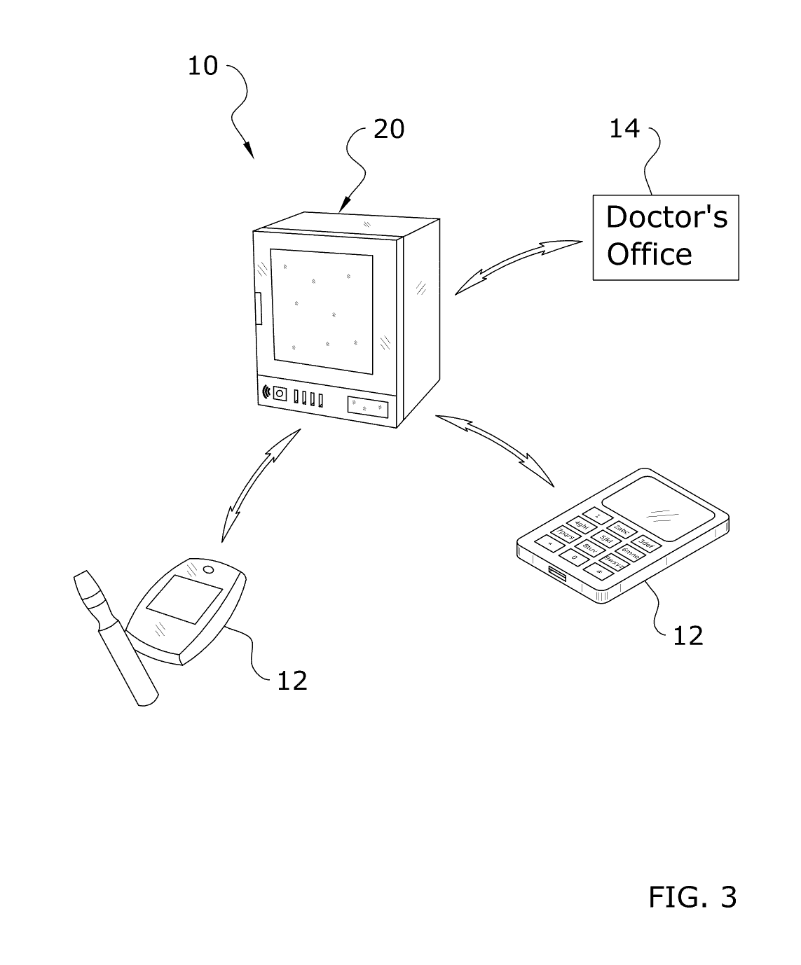

The housing 20 will generally include a front portion 21 and a rear portion 22. An access door 23 is preferably provided on the front portion 21 of the housing 20 to allow access to the interior 30. The access door 23 may be comprised of various structures and designs, though a swinging door 23 is utilized in a preferred embodiment. The present invention may also include a plurality of pockets 35 positioned on the interior side of the access door 23 for storing various items as shown in FIG. 3.

The access door 23 will generally include a display 24 as shown in FIG. 1. The display 24 is utilized to display various information to the patient, including information related to health and medications. In a preferred embodiment, the display 24 will be comprised of a touch screen so that a patient may make selections, navigate menus and input information. However, it is appreciated that, in some embodiments, a touch screen may not be utilized and instead a conventional display with some other form of data entry (i.e. a keypad) may be used for data entry.

The housing 20 will also generally include a locking member 25 to prevent unauthorized access to the interior 30 through the access door 23. Generally, the locking member 25 will be comprised of a structure or device which restricts opening of the access door 23 without entry of a code, key or the like. Various types of locking members 25 may be utilized without affecting the overall operation of the present invention so long as opening of the access door 23 is restricted to authorized parties.

The housing 20 will also generally include a transceiver 26 and a data reader 27. While the figures illustrate the transceiver 26 and data reader 27 on the front portion 21 of the housing 20, it is appreciated that they may be positioned at various other locations of the housing 20 to suit different applications. The data reader 27 may be utilized to read various forms of data. In a preferred embodiment, the data reader 27 will be configured to read at least barcodes.

The housing 20 may also include a memory port 28 and/or hard disk drive 29. The memory port 28 may be configured to read various types of memory, including USB, flash cards and the like. The hard disk drive 29 may be comprised of a removable hard disk drive 29 in some embodiments. While the figures illustrate the memory port 28 and hard disk drive 29 on the front portion 21 of the housing 20, it is appreciated that they may be positioned at various other locations of the housing 20 to suit different applications.

The transceiver 26 of the present invention is utilized to both transmit and receive data with outside devices and/or locations such as mobile devices 12 or a doctor's office 14. The transceiver 26 may be comprised of various communication connections, including BLUETOOTH, Wi-Fi, Ethernet, RF and the like. Mobile devices 12 may include cell phones, smart phones, PDA's, portable medical scanners (such as pulse detectors) and the like.

It is appreciated that the transceiver 26 may be adapted to transfer data through more than one type of connection and thus should not be limited to any one of the communication connections listed. Further, various other types of communication connections may be utilized so long as the transceiver 26 is capable of efficiently transferring data to outside sources.

FIG. 3 illustrates various types of connections capable of being made with the present invention. As shown in FIG. 3, the present invention may connect to various types of mobile devices 12 through the transceiver 26. Similarly, the present invention may connect to a doctor's office (i.e. a computer at the doctor's office) through the transceiver 26.

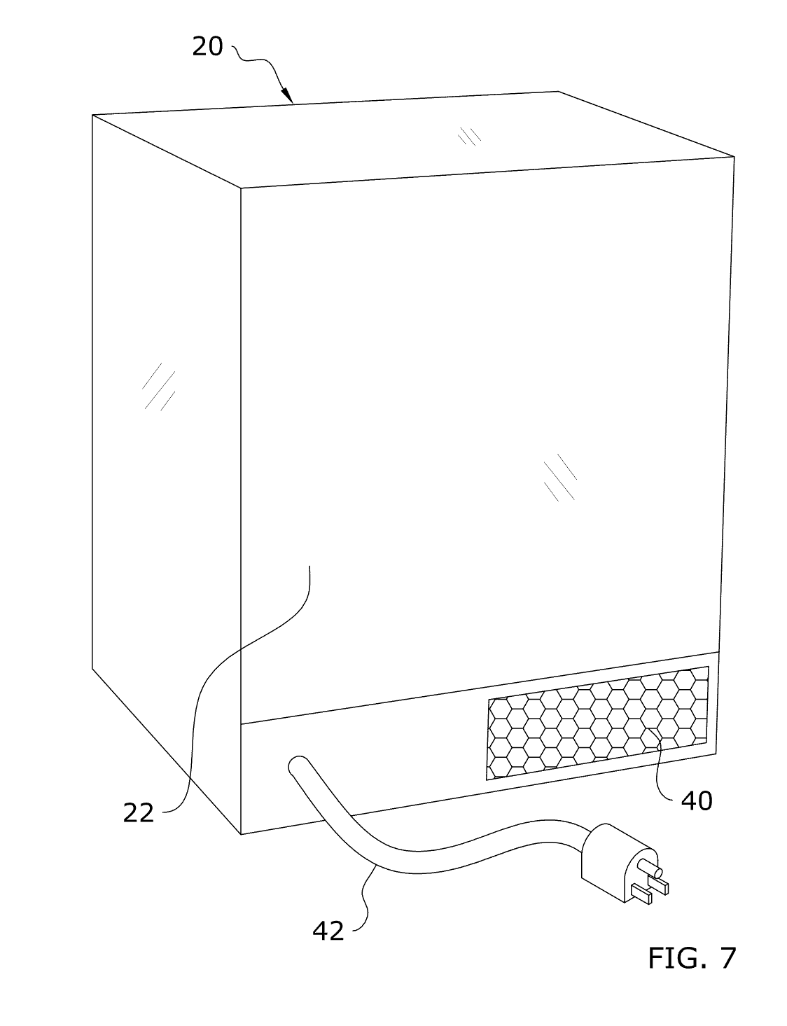

As shown in FIG. 7, the present invention will also generally include a cooling vent 40 and power cord 42, both of which will preferably be positioned on the rear portion 22 of the housing 20. The cooling vent 40 may be utilized to keep medications cool within the medication chambers 32 if so needed.

### C. Interior.

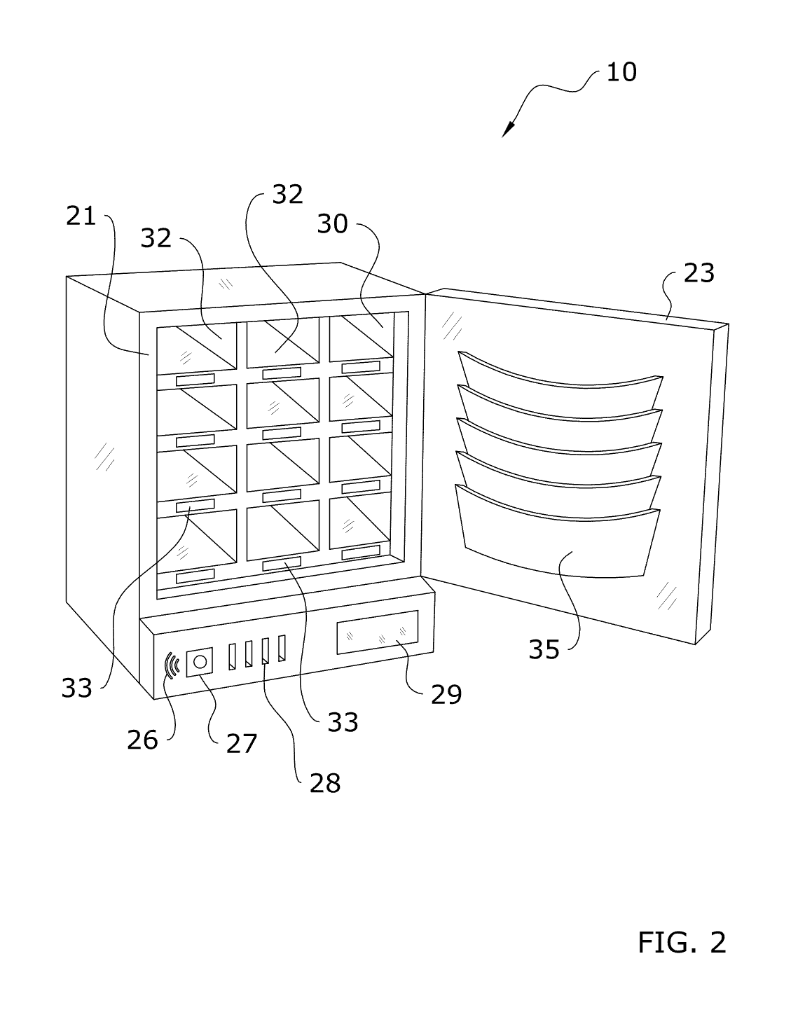

As shown in FIG. 2, the housing 20 will generally include an interior 30 in which medications may be stored and from which medications may be retrieved. The interior 30 of the housing 20 is generally accessible through the access door 23 positioned on the front portion 21 of the housing 20.

The interior 30 of the housing 20 will generally include a plurality of medication chambers 32 for storing different types of medication. The medication chambers 32 will generally be comprised of separate modules, each of which include a chamber display 33 positioned thereunder. The chamber display 33 will generally be comprised of a light or other indicia which may be utilized to identify the medication stored in the particular medication chamber 32. The chamber display 33 may also light up to indicate when a particular medication may be taken.

### D. Operation of Preferred Embodiment.

The present invention may be utilized to perform various functions for managing health information and medication. The present invention includes various methods for alerting a patient of the exact time to take medication, whether the patient is at home or away. Further, the present invention will monitor the occurrence of side effects and store the name of drugs which cause allergies or side effects for the patient. By doing so, the present invention may warn the patient not to take certain medications.

The present invention will also save the medical history of a patient and link to the patient's medical history via the Internet or other communications network. The present invention may also communicate and update the patient's records at the doctor's office 14 through use of the transceiver 26. The present invention also may recognize changes in health through readings taken through various mobile devices 12.

The present invention may also save and follow up on vital signs and health changes of the patient, which may include without limitation glucose level, blood pressure, cholesterol level and blood viscosity level through connections with medical mobile devices 12 such as blood pressure monitors and the like.

The present invention may also communicate and display information stored thereon via mobile devices 12, computers or electronic files stored at a doctor's office 14. Further, the present invention may include an option to determine a lost dose due to the patient forgetting to take it or vomiting. In these circumstances, the present invention will direct the patient to take another dose. Additionally, the present invention may include an option to synchronize medication intake with meals when necessary, with an option to specify the exact period between meals and drug intake. Doses for drugs may also be incremented, with the gradient calculated at the time of data entry or through the doctor's office 14.

The present invention will generally include a processor (such as a CPU) and some form of data storage (i.e. a hard drive, flash drive or the like). An operating program will generally be stored that may be utilized in directing the display 24 of the present invention and managing data storage and communications with mobile devices 12 or a doctor's office 14.

In use, the present invention may be connected to various mobile devices 12 through the transceiver 26. Similarly, the present invention may be connected to a doctor's office 14 through the Internet or other communications network. Data may be entered into the present invention either through the transceiver 26 or the data reader 27. Data which may be stored on the present invention includes the patient's name, age, name of the disease, name of the drug, dosage, expiration date, dose time, duration of medication use, the patient's mobile number, e-mail address and any other information concerning the patient, his/her health and medication. The operating program also allows the entry of follow up appointments with doctors and laboratory test appointments and alert the patient before the times of those appointments.

Data entry is performed through electronic programming of the medication at the clinic or pharmacy in the form of a barcode, or any similar method, pasted on the medication. This information should at least include the name of the patient, the patient's file number at the hospital, name of the drug, dosage, number of doses, period of use and expiration date. The data is scanned using the data reader 27 or any similar method, in the present invention at home where the data is automatically entered. The present invention is also connected to the electronic file of the patient in the hospital through an applicable connection, for example but not limited to a wired or a wireless network where it is confirmed that the patient has obtained the drug and is reminded to get a refill before it runs out.

The operating program used in this invention allows the entry of several drugs' information for the same patient. They also allow the entry of the drugs' information for different patients where each user could have a separate file containing all his/her health information in addition to contact information that include e-mail address, mobile number, and the electronic file information at the hospital.

The present invention may also be connected to the Internet, where information may be displayed and automatically updated on a web page such as GOOGLE HEALTH, MICROSOFT HEALTH VAULT, WEBMD HEALTH RECORD and the like.

When entering a drug's information for the first time, the period of use is specified or it could be left open in the case of chronic medication. The present invention alerts the patient to get a refill before the medication runs out. The patient could also be alerted through a reminder message from the patient's electronic file at the hospital.

Times of doses are programmed based on sleeping and meal schedules. They could be modified according to the patient's preference. The programming can also increment the doses for the drugs that require so, where the gradient can be calculated at the time of data entry or through the patient's electronic file at the hospital by the doctor or pharmacist. The programming also includes the option of synchronizing drug intake time with meals when necessary. The period between meals and dose time could be specified in the case of medications that need to be taken before/after meals.

The operating program contains the option to specify the occurrence of side effects and adverse reactions to drugs and place it in the list of contraindications, where the patient is warned in case he/she was prescribed this drug again in the future.

The device alerts the patient in the specific time to take the medication. The screen displays the information mentioned above, where the sound alarm lasts as long as the user specifies. The sound alarm is combined with a light signal on the chamber display 33 that lasts until the patient turns it off or until the next sound alarm for another drug or another dose. The light signal may include several colors, where a specific light color could be set up for each patient or each drug depending on the number or preference of the users. There is also the option of choosing different alarm tones and specifying a tone for each user or drug.

A picture of the drug (bottle and content) is displayed on the display 24 to avoid confusion. There is also an option of displaying a picture of the patient (real or animated), which is obtained through a camera on the main device (not shown) or uploaded onto the program during data entry.

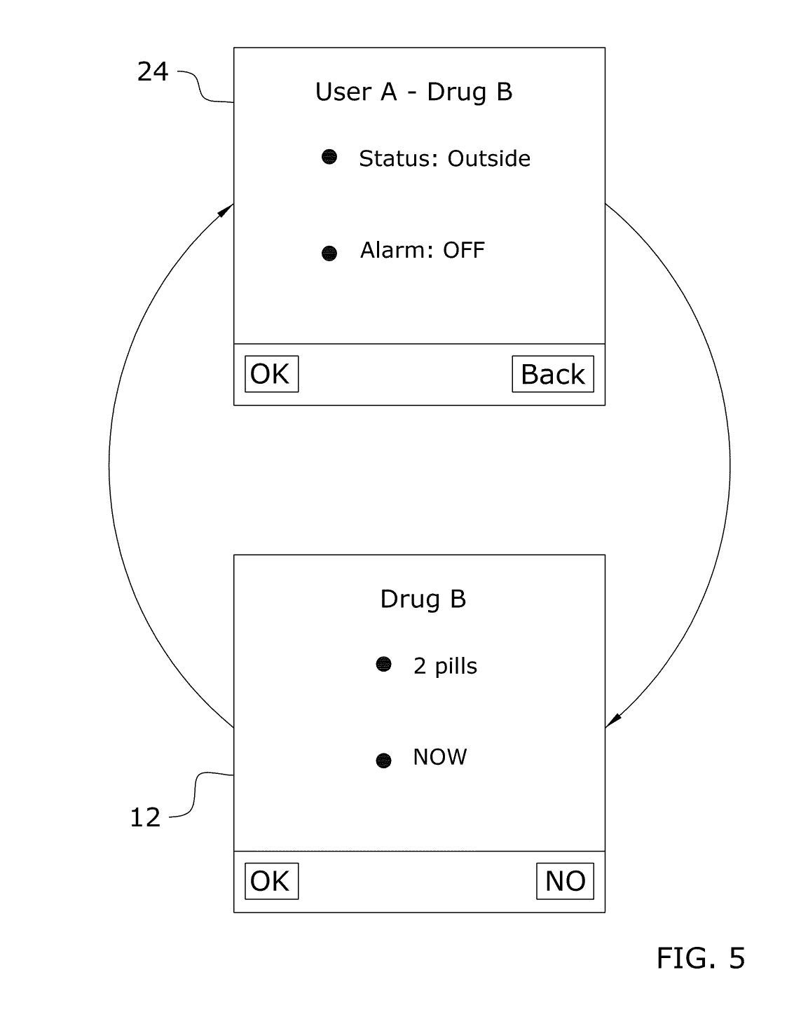

In the case of not responding to the alerts, a reminder message, which requires a confirmation from the patient back to the device confirming that the drug was taken to switch off the alarm, is sent to the patient's mobile phone or e-mail address through an application program that allows data exchange between the main device of the invention and the mobile devices 12 the patient uses as shown in FIG. 5. The messages sent to and from the device 12 are in the form of HL7 V3 or any other form suitable for information transfer and compatible with medical devices.

In the case of delay in taking the medication, the present invention automatically delays the next dose according to the amount of delay to maintain the correct period between doses when necessary, where this feature can be disabled or enabled.

The programs in the present invention contain an option for missed doses in the case of losing the dose or immediate vomiting, in order for the device to be able to calculate the actual doses taken by the patient in a specified period.

When the patient is not home, the present invention may be set to send outside reminders. In that case, a reminder text message requiring confirmation is sent from the present invention at the specific time without the alarms going off in the main device. A text message requiring confirmation is sent to the patient, where the present invention can calculate missed doses, and the patient's compliance while not home and reminds the patient when it's time to take the medication.

The present invention allows the patient to inquire about the next dose time through the display 24, so he/she can take the needed medication with him before going out. The patient can reach the present invention while away from home through a phone or computer application, where he/she can view the times to take medications, medical reports and other health information saved on the main device.

The present invention allows the user to enter follow-up appointments with doctors and timings of laboratory tests through the programs mentioned above. The user is alerted about those appointments before they occur through the sound alarm and through sending a text message requiring confirmation to the user's mobile phone. The inside of the access door 23 contains leather pockets 35 to keep appointment slips and prescriptions.

The present invention sends a report after a certain period of use, which gives the patient an estimate about his/her medication compliance. It congratulates the patient when not missing any doses, or it warns him/her that medication noncompliance could cause dangerous complications when a specific number of doses are missed. This report could be exchanged between the present invention and various mobile devices 12.

When a specific number of doses are missed, the present invention sends an alert message to a contact person, specified by the user. This contact person could be a family member, friend or a physician that can discuss the reasons behind noncompliance with the patient and help the patient in taking his/her medication on time. To accomplish this, the patient must enter the contact information of this person, including name, mobile phone number and e-mail address. This could also be accomplished by linking the device to the patient's electronic health file in the hospital.

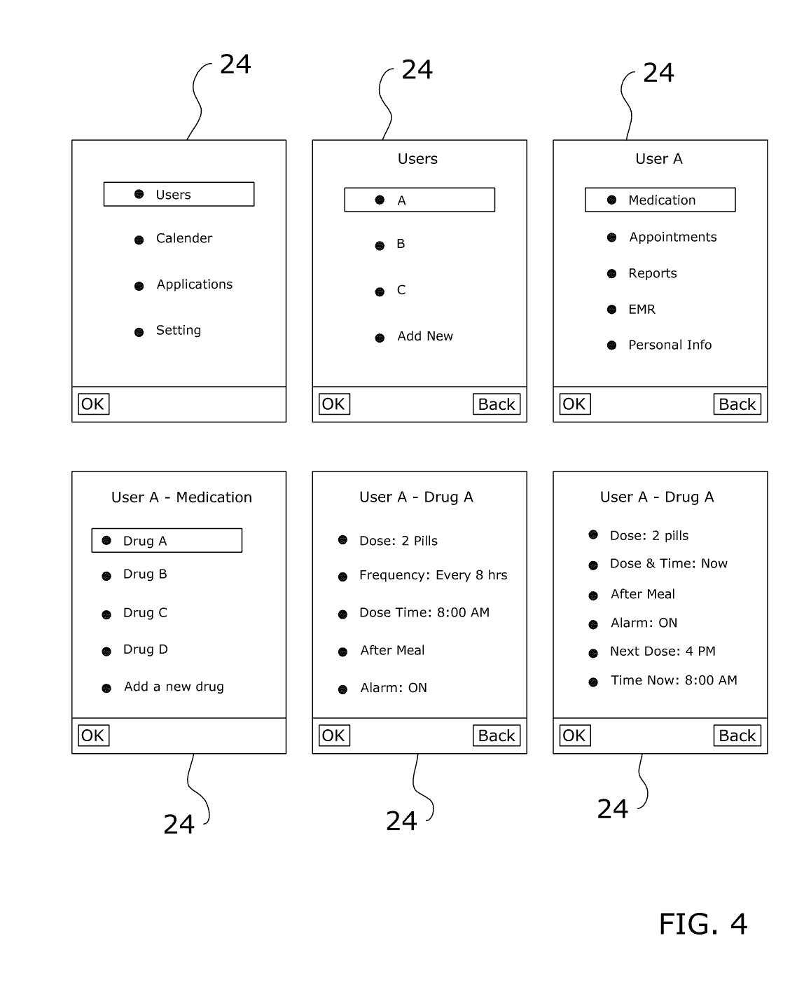

The device provides a detailed medication history of the patient through a detailed report that contains all the names of the drugs being taken by the patient, doses and dose period as shown in FIG. 4. This could help in linking some drugs with the side effects experienced when knowing when using this drug has started and when it ended, for example a rash caused by some medications.

The present invention assists in storing the readings of glucose level, blood viscosity level, blood pressure, Cholesterol level, temperature, weight and any other important health outcomes. This is accomplished through connections with the other devices 12 via applicable connection methods, which could include but is not limited to barcode reader, Bluetooth, wireless network and manual data entry. This data can be saved using special programs on the main device, which forms a personal health record (PHR) comprehensive of all the important health information of the patient obtained at home. This could help the physician in taking the right decision about the treatment plan for the patient.

The device is connected to the electronic health record of the patient in the hospital through a program that allows data exchange. This is accomplished through any applicable communication method, which could include but is not limited to a wireless network. A text message that requires a confirmation is sent from the hospital to the device and subsequently to the mobile phone or e-mail address to remind the patient of his follow-up appointment with the doctor. The options in the text message allow confirmation or delaying of the appointment. Text messages can also be sent to remind the patient to get medication refills or inform him of laboratory test results.

The present invention may also provide a report after a specific treatment time. Such a report gives the patient an estimate about medication compliance. It can either provide positive reinforcement when a patient has not missed any doses, or it may warm the patient that noncompliance could cause dangerous complications after a specific number of doses are missed. The report may be communicated via various methods, including the present invention itself, mobile devices 12 and other computer devices.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

1. A medication management device, comprising:
a housing having a front portion and a rear portion, wherein said housing includes an interior;
a plurality of medication chambers positioned within said interior;
a display positioned on said front portion of said housing;
a central processing unit;
a transceiver for communicatively interconnecting with at least one mobile device, wherein said transceiver is adapted to remotely connect to a doctor's office via a communications network for transferring data; and
a data reader.

2. The medication management device of claim 1, further comprising at least one chamber display positioned adjacent each of said plurality of medication chambers.

3. The medication management device of claim 1, further comprising an access door, wherein said access door is adapted to provide access to said interior of said housing.

4. The medication management device of claim 3, further comprising a locking member on said access door.

5. The medication management device of claim 1, wherein said data reader is comprised of a barcode scanner.

6. The medication management device of claim 1, wherein said transceiver is adapted to communicate via Wi-Fi.

7. The medication management device of claim 1, wherein said display is comprised of a touch screen.

8. The medication management device of claim 3, wherein said access door includes at least one pocket.

9. The medication management device of claim 1, further comprising a cooling vent for providing cooling to said interior.

10. The medication management device of claim 1, wherein said housing includes a camera.

11. A medication management device, comprising:
a housing having a front portion and a rear portion, wherein said housing includes an interior;
an access door positioned on said front portion of said housing;
a plurality of medication chambers positioned within said interior;
a plurality of chamber displays, each of which is positioned adjacent each of said plurality of medication chambers;
a touch screen display positioned on said front portion of said housing;
a central processing unit;
a storage device for storing data;
a transceiver for communicatively interconnecting with at least one mobile device, wherein said transceiver is adapted to remotely connect to a doctor's office via a communications network for transferring data; and
a data reader.

12. The medication management device of claim 11, wherein said display is adapted to receive patient-inputted data, wherein said data is stored on said storage device.

13. The medication management device of claim 11, wherein said data reader is adapted to receive data, wherein said data is stored on said storage device.

14. The medication management device of claim 13, wherein said data reader is comprised of a barcode scanner.

15. (canceled)

16. The medication management device of claim 11, wherein said transceiver is adapted to connect to a mobile device for transferring data.

17. The medication management device of claim 11, wherein said chamber display is adapted to display a type of medication and wherein said chamber display is adapted to provide an alarm when a medication should be taken by a patient.

18. The medication management device of claim 16, wherein said transceiver transmits a message to said mobile device when a medication should be taken by a patient.

19. The medication management device of claim 18, wherein said display is adapted to show a representation of a medication to be taken.

20. A medication management device, comprising:
a housing having a front portion and a rear portion, wherein said housing includes an interior;
an access door positioned on said front portion of said housing, wherein said access door includes at least one pocket;
a locking member on said access door;
a plurality of medication chambers positioned within said interior;
a plurality of chamber displays, each of which is positioned adjacent each of said plurality of medication chambers;
a touch screen display positioned on said front portion of said housing;
a central processing unit;
a storage device for storing data;
a camera positioned on said housing for displaying pictures, wherein said pictures are selected from a group consisting of a picture of a medication and a picture of a patient;
a cooling vent for providing cooling to said interior;
a transceiver for communicatively interconnecting with at least one mobile device, wherein said transceiver is adapted to remotely connect to a doctor's office via a communications network for transferring data, wherein said transceiver is adapted to communicate via Wi-Fi; and
a data reader, wherein said data reader is comprised of a barcode reader.
